(19) United States
(12) Patent Application Publication
(10) Pub. No.: US 2012/0018385 A1
(43) Pub. Date: Jan. 26, 2012

(54) RECOVERING HYDROCARBONS

(75) Inventors: Gary Broberg, Brookpark, OH (US); David Akers, Bainbridge, OH (US)

(73) Assignee: COLLABORENT GROUP, LTD., Cleveland, OH (US)

(21) Appl. No.: 12/842,795

(22) Filed: Jul. 23, 2010

(51) Int. Cl. E02B 15/04; C02F 1/40; C02F 1/28

(52) U.S. Cl. 210/691

(57) ABSTRACT

Methods of recovering hydrocarbons from an area that is contaminated or threatened with contamination with hydrocarbons may include deploying hydrophobic absorbent material such that at least some of the hydrophobic absorbent material contacts at least some of the hydrocarbons, allowing the hydrophobic absorbent material to absorb at least some of the hydrocarbons, and collecting the hydrophobic absorbent material from the area using a netting apparatus. The hydrophobic absorbent material may include cellulose treated with borax.

### FIELD OF THE INVENTION

The present application relates to methods and systems for recovering hydrocarbons to clean up contaminated areas or to prevent contamination of threatened areas.

### BACKGROUND

The oil spill of April 2010 in the Gulf of Mexico served as a reminder of the large quantities of oil and other hydrocarbons that may be released onto land and sea and can damage beaches, marshes, shores, and harbors as well as marine fauna and flora. The spill also served as a reminder of the need for systems and methods to quickly and effectively recover oil and other hydrocarbons from spills to prevent or minimize damage.

Conventional hydrocarbon recovery systems and methods such as conventional boom, skimming methods, filtering methods, vacuuming methods, soaking methods, dispersant chemicals, etc. all have limitations that are well documented. Some of these systems and methods, for example, have limitations involving the separation of water from hydrocarbons during the process of recovering hydrocarbons from a body of water. A soaking method, for example, may soak large quantities of water together with the hydrocarbons causing problems related to disposal of the soaking material and the hydrocarbons and water mix. Some of these systems and methods also have limitations related to the toxicity of chemicals and other materials used in the recovery process.

### SUMMARY OF THE INVENTION

Methods of recovering hydrocarbons from an area that is contaminated or threatened with contamination with hydrocarbons may include deploying hydrophobic absorbent material such that at least some of the hydrophobic absorbent material contacts at least some of the hydrocarbons, allowing the hydrophobic absorbent material to absorb at least some of the hydrocarbons, and collecting the hydrophobic absorbent material using a netting system. The hydrophobic absorbent material may include cellulose treated with borax.

### BRIEF DESCRIPTION OF THE DRAWINGS

The accompanying drawings, together with the detailed description provided below, describe exemplary embodiments of the claimed invention. In the drawings and description that follow, like elements are identified with the same reference numerals. The drawings are not drawn to scale and the proportion of certain elements may be exaggerated for purposes of illustration.

While for purposes of simplicity of explanation, disclosed methods are described as a series of steps, it is to be appreciated that the methods are not limited by the order of the steps, as some steps can occur in different orders or concurrently with other steps described. Moreover, less than all the described steps may be required to implement an example method. Furthermore, additional or alternative methods can employ additional, not described steps.

FIGS. 1A, 1B, and 1C illustrate side, front, and top views, respectively, of an exemplary embodiment of a system for recovering hydrocarbons from the surface and near surface of a body of water.

FIGS. 2A, 2B, and 2C illustrate side, front, and top views, respectively, of an exemplary embodiment of a system for recovering hydrocarbons from the surface and near surface of a body of water.

FIGS. 3A, 3B, 3C, and 3D illustrate an exemplary system for recovering a hydrocarbon material from a body of water and areas near the body of water.

FIGS. 4A, 4B, and 4C illustrate an exemplary system for recovering hydrocarbons from an area that is contaminated or threatened with contamination with the hydrocarbons.

### DETAILED DESCRIPTION

The disclosed systems and methods of recovering hydrocarbon materials include deploying a hydrophobic absorbent material onto or near a surface from which the hydrocarbon materials are to be recovered. Hydrocarbon materials that are recoverable by using the disclosed systems and methods include, but are not limited to, petroleum-based materials, oil, diesel, xylene, touluene, benzene, gasoline, and bunker C oil.

In one embodiment, the hydrophobic absorbent material includes a hydrocarbon absorbent material such as cellulose. Types of cellulose that may be used for the hydrophobic absorbent material include, but are not limited to, paper, paperboard, card stock, cardboard, and textiles made from cotton, linen, and other plant fibers. In one embodiment, the hydrophobic absorbent material includes recycled cardboard material. In other embodiments, the hydrophobic absorbent material would include materials other than cellulose or a combination of materials that have hydrocarbon absorption qualities similar to those of cellulose.

In one embodiment, the hydrophobic absorbent material includes a hydrocarbon absorbent material which has been treated with a chemical that makes the combination of the hydrocarbon absorbent material and the chemical simultaneously hydrocarbon absorbent and hydrophobic. In one embodiment, the hydrocarbon absorbent material is treated with borax (i.e. hydrated and non-hydrated sodium borate). Borax may have one or more of the chemical formulas Na₂B₄O₇, Na₂B₄O₇.5H₂O, Na₂B₄O₇.10H₂O, Na₂[B₄O₅(OH)₄].8H₂O, and so on. In other embodiments, the hydrophobic absorbent material would include a chemical other than borax that would impart the combination of the hydrocarbon absorbent material and the chemical with hydrocarbon absorbent and hydrophobic qualities simultaneously. In one embodiment, the hydrocarbon absorbent material would be treated with wax (e.g. bee's wax, paraffin wax, and so on) to make the combination of the hydrocarbon absorbent material and the wax simultaneously hydrocarbon absorbent and hydrophobic.

In one embodiment, the hydrophobic absorbent material is a commercially available material such as K-Sorb Hydrophobic Particulate or K-Sorb Hydrophobic Fiber available from BioCel Technologies of Houston, Tex.

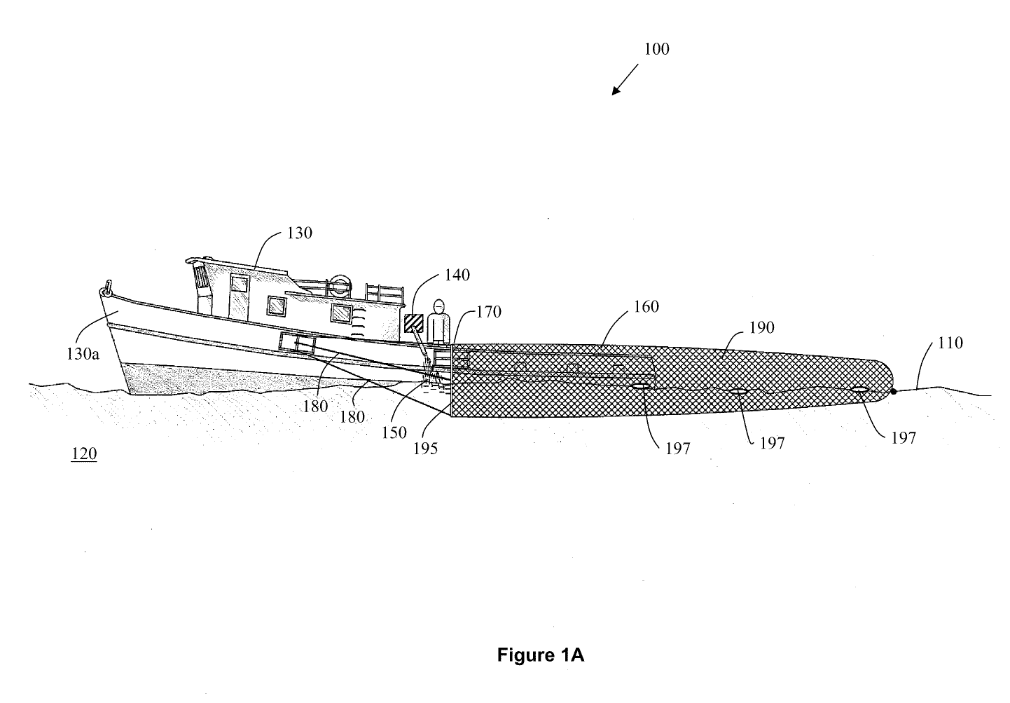

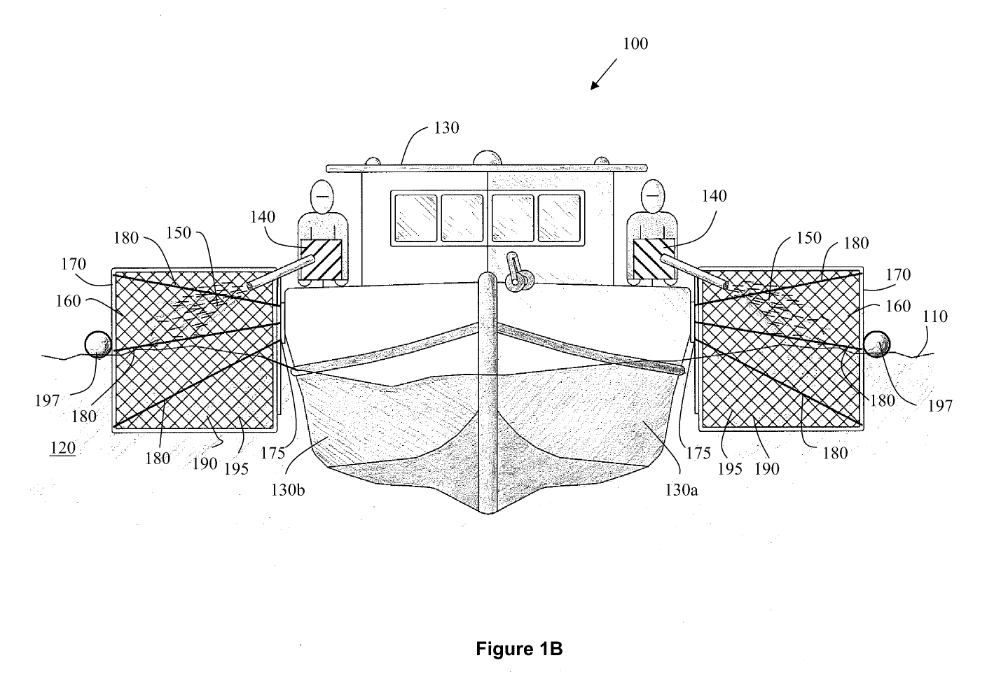

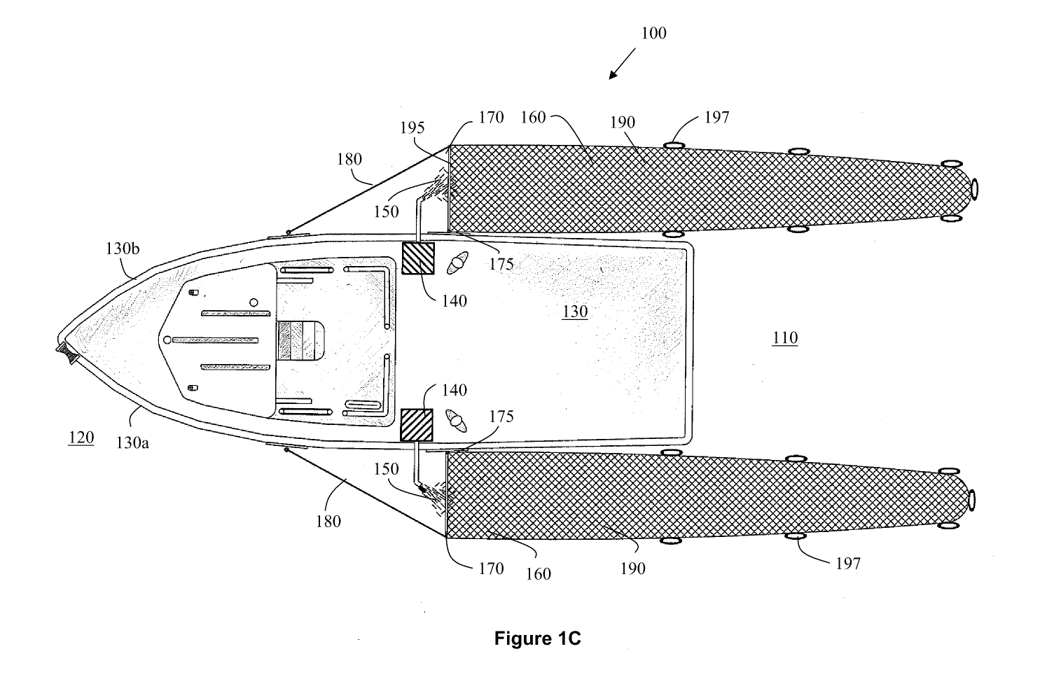

FIGS. 1A, 1B, and 1C illustrate side, front, and top views, respectively, of an exemplary embodiment of a system 100 for recovering hydrocarbons from the surface 110 and near surface of a body of water 120.

The system 100 includes a ship 130 in the body of water 120. In the illustrated embodiment, the ship 130 carries a mechanism 140 configured to deploy or assist in the deployment of the hydrophobic absorbent material 150 from the ship 130 and onto the surface 110 of the body of water 120. In one embodiment (not shown), the mechanism 140 resides on a ship other than ship 130. In another embodiment (not shown), the mechanism 140 resides somewhere other than on a water vehicle (e.g., a ship) such as an air vehicle, land vehicle, dock, land, and so on. In the illustrated embodiment, the mechanism 140 is shown as two units. In other embodiments (not shown), the mechanism configured to deploy or assist in the deployment the hydrophobic absorbent material may include more or less than two units such as one unit, or three or four units, for example.

The mechanism 140 may deploy or assist in the deployment of the hydrophobic absorbent material 150 from the ship 130 and onto the surface 110 of the body of water 120 by accelerating portions of the hydrophobic absorbent material 150 onto the surface 110 of the body of water 120. In one embodiment, the mechanism 140 deploys the hydrophobic absorbent material 150 by using pressurized air. In other embodiments, the mechanism 140 may deploy or assist in the deployment of the hydrophobic absorbent material 150 by using methods other than pressurized air (e.g. a mechanical process, a manual process, and so on).

The system 100 further includes two netting apparatus 160 operably attached to the ship 130 and configured to collect the hydrophobic absorbent material 150 from the surface 110 and near surface of the body of water 120 as the ship 130 moves in the water. In the context of the present disclosure, near surface is used to refer to water below the surface of the body of water, and, in certain embodiments, near surface may include water than is less than 1 foot below the surface or less than 2 feet below the surface. In other embodiments, near surface may include water that is further below the surface of the body of water.

In one embodiment (not shown), the mechanism 140 and the netting apparatus 160 reside on different ships. In other embodiments (not shown), one or more of the mechanism 140 and the netting apparatus 160 do not reside on a water vehicle (e.g., a ship), but instead reside somewhere other than a water vehicle (e.g. air vehicle, land vehicle, dock, land, and so on). In the illustrated embodiment, the netting apparatus 160 are shown as two units. In other embodiments, (not shown) the netting apparatus may include more or less than two units such as one unit, or three or four units, for example.

In the illustrated embodiment, each netting apparatus 160 includes a frame 170. The frames 170 operably attach to the port side of the hull 130a, and the starboard side of the hull 130b, respectively. In other embodiments (not shown), the frames 170 may operably attach to other portions of the ship 130 (e.g. bow, stern, deck, and so on). The frames 170 may be operably attached to the ship 130 using brackets 175 attached to the frames 170. The frames 170 may also be operably attached to the ship 130 using ropes 180 attached to the frames 170 and to the ship 130. Although the ropes 180 are illustrated attached to certain portions of the ship 130, the ropes 180 may be attached to other portions of the ship 130. More than one type of attachment may be used to operably attach the frames 170 to the ship. Although, the frames 170 are illustrated in FIG. 1B as being generally rectangular, the frames 170 may have shapes other than rectangular (e.g. circular, oval, and so on). In one embodiment, the frames 170 are constructed of aluminum. In other embodiments, the frames 170 are constructed of materials other than aluminum (e.g. steel, composite, plastic, and so on).

The netting apparatus 160 also include nets 190 attached to the frames 170. The nets 190 are configured to capture the hydrophobic absorbent material 150. Each of the nets 190 has at least one major opening 195 where the hydrophobic absorbent material 150 may enter the nets 190. The nets 190 are constructed from mesh-like material and of materials suitable to capture or contain the hydrophobic absorbent material 150 while still allowing water to pass through. In one embodiment, the nets 190 are constructed from a commercially available knotless nylon mesh such as ¼″ Ace Knotless Netting available from Mid-Lakes Corporation of Knoxville, Tenn. In other embodiments, the nets 190 are constructed from knotted meshes or of materials other than nylon (e.g. polyamides, polyester, wool, plastic, metal, poultry netting, and so on).

In the illustrated embodiment, the nets 190 have attached floating devices 197 around the nets 190 such that the nets 190 do not sink into the body of water 120, but remain substantially near, on, or above the surface 110 of the body of water 120. Although, a certain number of floating devices 197 are illustrated, more or less floating devices may be included. Although floating devices are shown in the illustrated embodiment, their inclusion with the nets and netting apparatus is not required, but, rather should be understood as optional.

In one embodiment, the nets 190 are removably attached to the frames 170 such that the nets 190 may be easily removed from the frames 170. In another embodiment (not shown), the netting apparatus 160 each includes two frames. The first frame operably attaches to the net near the major opening of the net. The second frame operably attaches to the ship 130. The first frame and the second frame are removably attached such that the net may be easily removed by removing the first frame from the second frame. In other embodiments, the netting apparatus 160 each includes more or less than two frames arranged in reference to the nets such that the netting apparatus 160 may capture the hydrophobic absorbent material 150 while allowing the water to pass through the nets and such that the nets may be easily removed.

In one embodiment (not shown), the netting apparatus includes a frame that has operably attached at least one diving lip extending from the bottom of the frame such that, when deployed, at least a portion of the at least one diving lip is submerged in the body of water so that hydrocarbons below the surface of the water (e.g. plumes, and so on) are caused to rise to the surface and near surface and from there may be captured by using systems such as the system 100. In other embodiments, the diving lip may be deployed attached to other parts of the ship independent of the frame, or attached to a second ship.

In one embodiment (not shown), the netting apparatus includes a frame having one or more flaps operably attached. The flaps may extend from the front end of the frame such that, when deployed, the flaps and frame act as a funnel directing at least some of the hydrophobic absorbent material towards the net to aid in collecting the material.

Therefore, a method of recovering hydrocarbons from the surface 110 and near surface of the body of water 120 may include deploying the hydrophobic absorbent material 150 from the ship 130 and onto the surface 110, allowing the hydrophobic absorbent material 150 to absorb at least some of the hydrocarbons, and collecting the hydrophobic absorbent material 150 into the netting apparatus 160 operably attached to the ship 130.

In one embodiment, deploying the hydrophobic absorbent material 150 from the ship 130 and onto the surface 110 includes accelerating portions of the hydrophobic absorbent material 150 onto the surface 110 by using pressurized air, a mechanical process, a manual process, a combination thereof, and so on.

In one embodiment, allowing the hydrophobic absorbent material 150 to absorb at least some of the hydrocarbons includes aiding the absorptions such as by controlling the navigation speed or direction of the ship 130. The navigation speed of the ship 130 may be controlled such that the hydrophobic absorbent material 150 absorbs at least some of the hydrocarbons prior to collecting the hydrophobic absorbent material 150 in the netting apparatus 160 or such that the hydrophobic absorbent material 150 absorbs at least some of the hydrocarbons after the hydrophobic absorbent material 150 has been collected in the netting apparatus 160.

The method of recovering hydrocarbons from the surface 110 and near surface of the body of water 120 may further include, in any order, removing the nets 190 from the frames 170, closing the nets 190 such that the collected hydrophobic absorbent material 150 is substantially enclosed, and removing the nets 190 with the collected hydrophobic absorbent material from the body of water 120. Removing the nets 190 from the body of water 120 may include lifting the nets 190 from the water. The nets 190 may be removed from the body of water to the deck of the ship 130, the deck of another ship, land, a barge, a dock, a truck, a helicopter, and so on. In some embodiments, the net may first be floated or pulled behind a ship to remove it from the collection area and later placed onto a ship, barge, dock, truck, helicopter or other vehicle

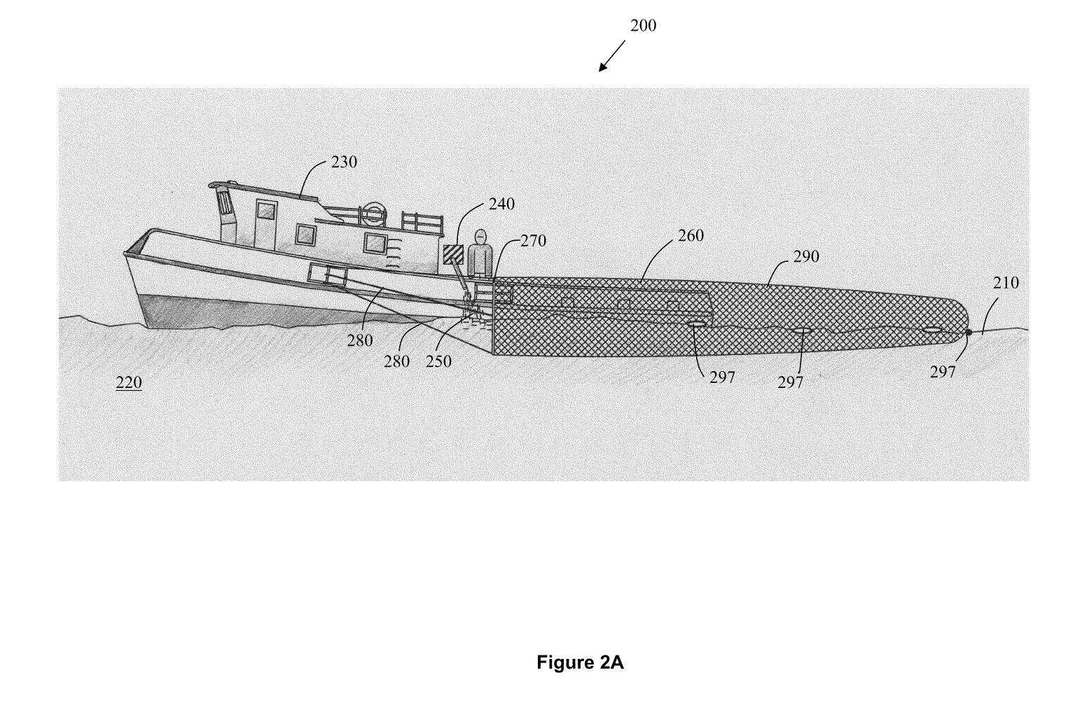

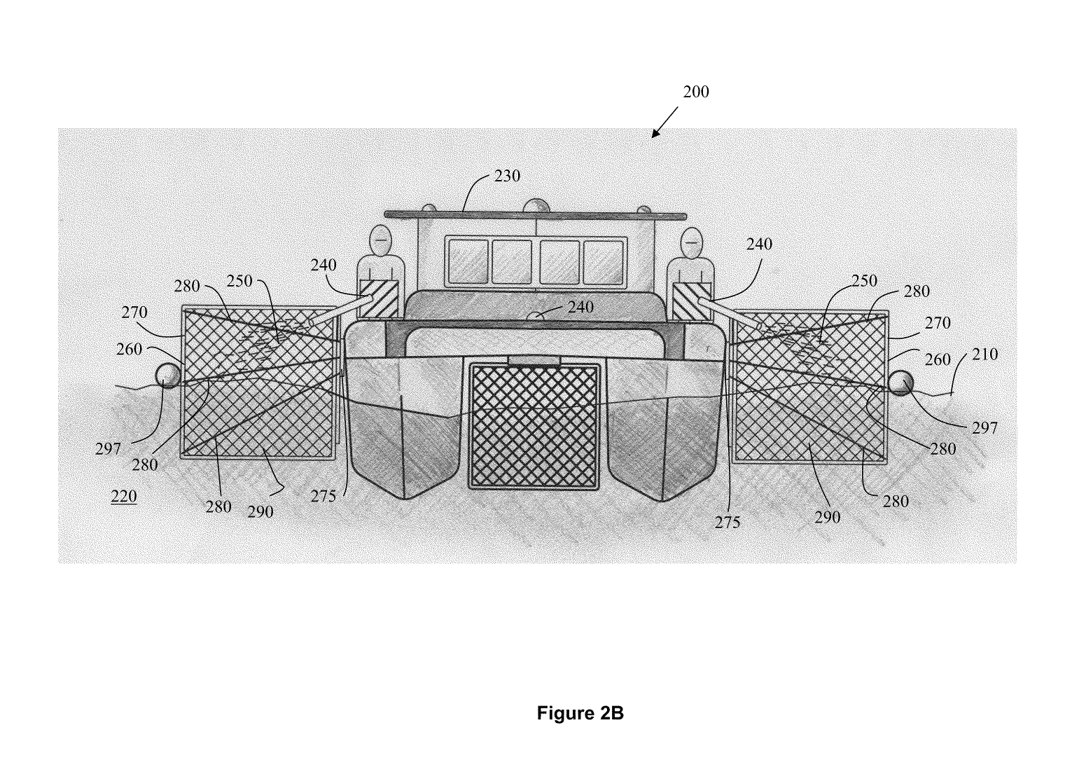

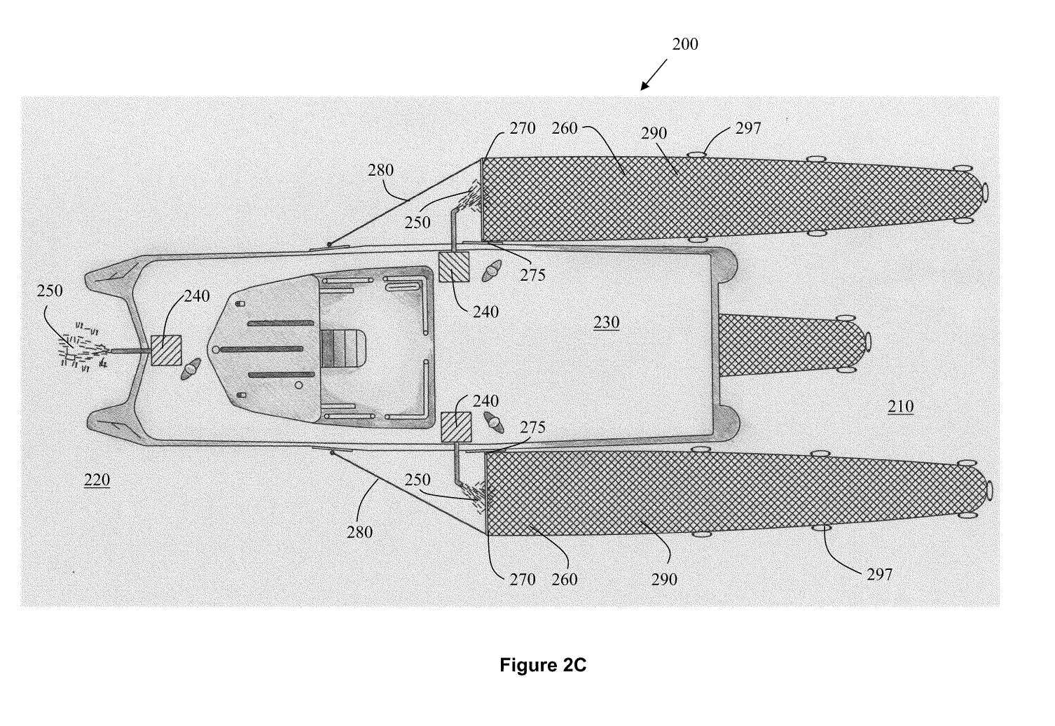

FIGS. 2A, 2B, and 2C illustrate side, front, and top views, respectively, of an exemplary embodiment of a system 200 for recovering hydrocarbons from the surface 210 and near surface of a body of water 220.

The system 200 is similar to the system 100 of FIGS. 1A, 1B, and 2C, with the main exception that system 200 includes a dual-hull or catamaran-type ship 230 with a mechanism 240 configured to deploy or assist in the deployment of the hydrophobic absorbent material 250 from the ship 230 and onto the surface 210 of the body of water 220. In the illustrated embodiment, the mechanism 240 includes three units. In other embodiments, (not shown) the mechanism 240 may include more or less than three units.

The system 200 further includes three netting apparatus 260 operably attached to the ship 230 and configured to collect the hydrophobic absorbent material 250 from the surface 210 and near surface of the body of water 220 as the ship 230 moves in the water. In the illustrated embodiment, each netting apparatus includes a frame 270 operably attached to ship 230. The frames 270 may be operably attached to the ship 230 using brackets 275. The frames 270 may also be operably attached to the ship 230 using ropes 280. More than one type of attachment may be used to operably attach the frames 270 to the ship. The netting apparatus 260 also includes nets 290 attached to the frames 270 and configured to capture the hydrophobic absorbent material 250.

In the illustrated embodiment, the nets 290 have attached floating devices 297 around the nets 290 such that they do not sink, but remain substantially near, on, or above the surface 210 of the body of water 220. Although, a certain number of floating devices 297 are illustrated, more or less floating devices may be included. Although floating devices are shown in the illustrated embodiment, their inclusion with the nets and netting apparatus is not required, but, rather should be understood as optional.

The nets 290 are removably attached to the frames 270 such that the netting apparatus 260 may capture the hydrophobic absorbent material 250 while allowing water to pass through and such that the nets 290 may be easily removed from the frames 270.

In one embodiment (not shown), the netting apparatus includes a frame that has operably attached at least one diving lip extending from the bottom of the frame such that when deployed at least a portion of the at least one diving lip is submerged in the body of water so that hydrocarbons below the surface of the water (e.g. plumes, and so on) are caused to rise to the surface and near surface and from there may be captured by using systems such as the system 200. In other embodiments, the diving lip may be deployed attached to other parts of the ship, independent of the frame or attached to a second ship.

In one embodiment (not shown), the netting apparatus includes a frame having one or more flaps operably attached. The flaps may extend from the front end of the frame such that when deployed the flaps and frame act as a funnel directing at least some of the hydrophobic absorbent material towards the net to aid in collection of the material.

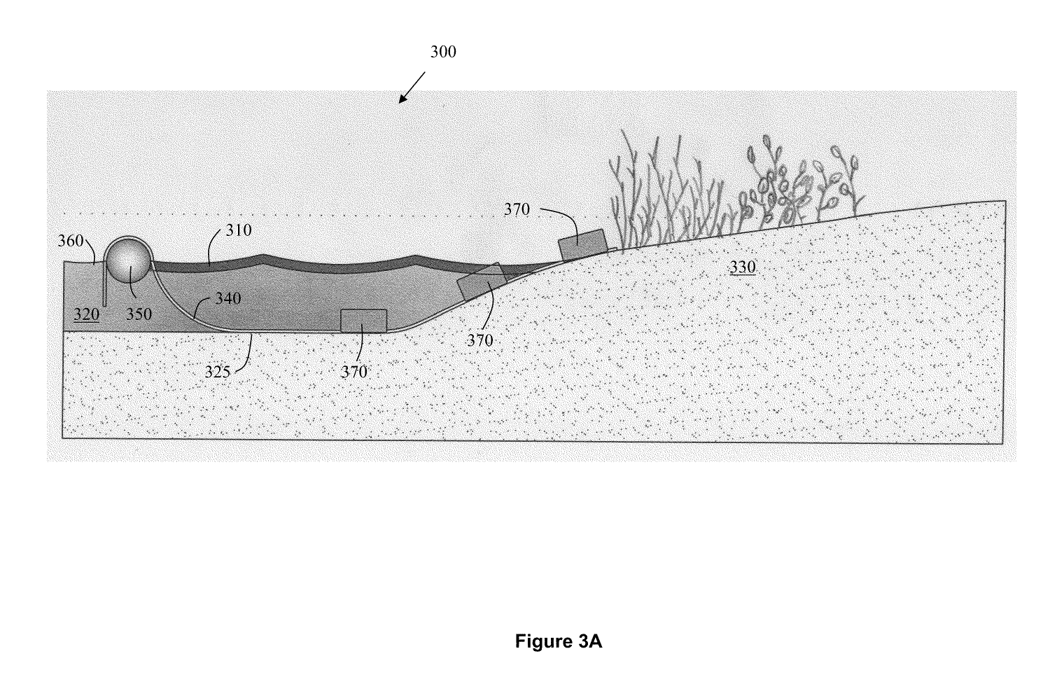

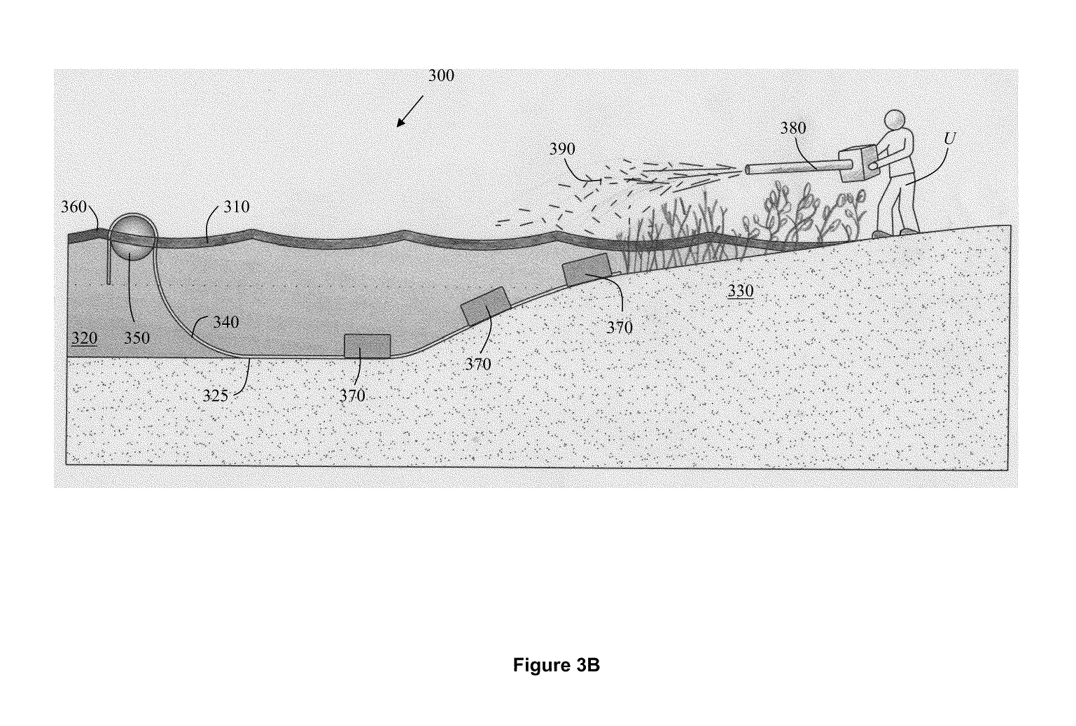

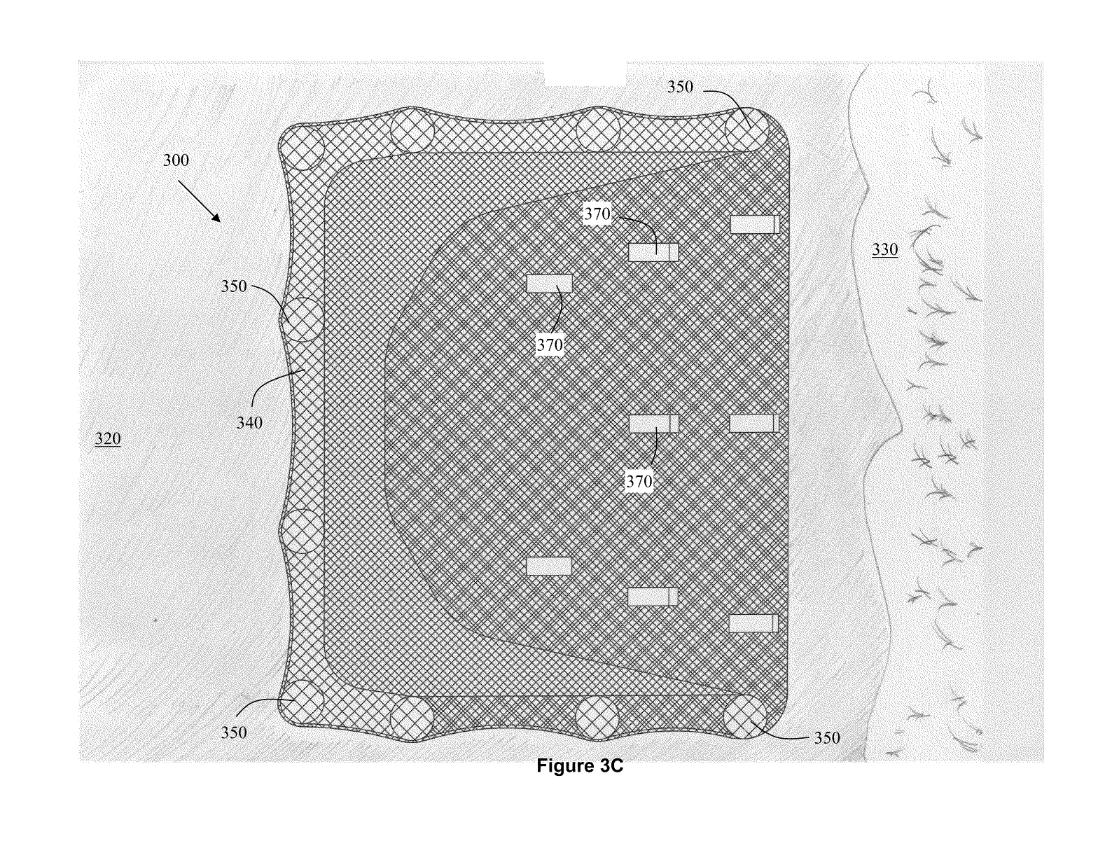

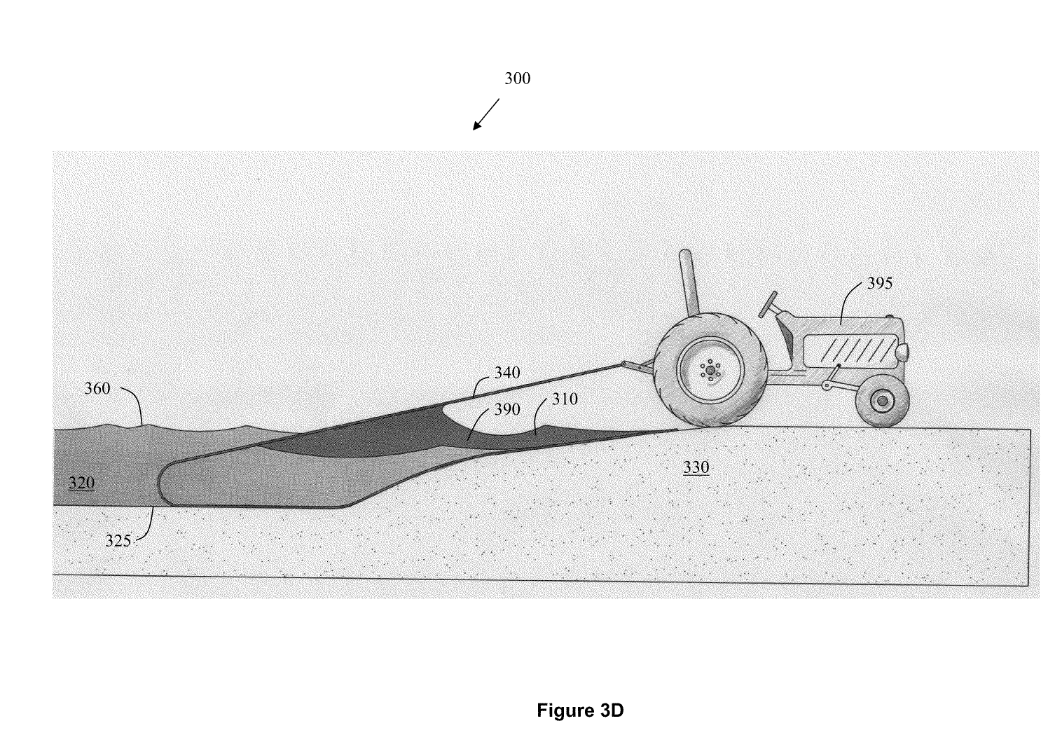

FIGS. 3A, 3B, 3C, and 3D illustrate a system 300 for recovering a hydrocarbon material 310 from a body of water 320 or areas 330 near the body of water 320. The system 300 includes a net 340 secured near a low tide edge of the body of water 320. The net 340 may optionally have attached floating devices 350 to keep portions of the net 340 substantially near, on, or above the surface 360 of the body of water 320. Although, a certain number of floating devices 350 are illustrated, more or less floating devices may be included. Although floating devices are shown in the illustrated embodiment, their inclusion with the nets and netting apparatus is not required, but, rather should be understood as optional.

The net 340 may further have attached optional weights 370 to secure portions of the net 340 substantially below the surface 360 of the body of water 320. Although, the weights 370 are illustrated as securing portions of the net 340 to the floor 325 below the body of water, the weights 370 need not secure portions of the net 340 to the floor 325, but need only to secure portions of the net 340 substantially below the surface 360 of the body of water. Although, a certain number of weights 370 are illustrated, more or less weights 370 may be included.

The system 300 further includes a mechanism 380 configured to deploy or assist in the deployment of hydrophobic absorbent material 390. In the illustrated embodiment, the mechanism 380 is shown as one unit being carried and operated by a user U. In other embodiments (not shown), the mechanism 380 may be, not carried or operated by a user, but instead mounted (e.g. removably mounted, permanently mounted, etc.) to a base, a vehicle, and so on and self-operated or operated by, for example, a machine. In other embodiments, (not shown) the mechanism configured to deploy or assist in the deployment of hydrophobic absorbent material may include more than one unit. In one embodiment, the mechanism 380 may deploy the hydrophobic absorbent material by accelerating portions of the hydrophobic absorbent material 380 by using pressurized air. In other embodiments, the mechanism 380 may deploy or assist in the deployment of the hydrophobic absorbent material 390 by using methods other than pressurized air (e.g. a mechanical process, a manual process, and so on).

In one embodiment, recovering a hydrocarbon material 310 from the body of water 320 or areas near the body of water 320 includes securing the net 340 near a low tide edge 350 of the body of water 320, deploying hydrophobic absorbent material 390 on an area on or near the body of water 320, allowing the hydrophobic absorbent material 390 to absorb at least some of the hydrocarbon material 310 from the body of water 320 or areas near the body of water 320, and collecting the hydrophobic absorbent material 390 containing at least some of the hydrocarbon material 310. The hydrophobic absorbent material 390 is deployed on the area on or near the body of water 320 such that at high tide at least some water from the body of water 320 contacts at least some of the deployed hydrophobic absorbent material 390 and such that at a subsequent low tide at least some of the hydrophobic absorbent material 390 floats with the tide towards the net 340. During the transition from high tide to low tide, at least some of the hydrophobic absorbent material 390 floats with the tide towards the net 340 as the tide is going out.

In the context of this disclosure, near the low tide edge of the body of water in some embodiments may mean within 10 feet from the edge of the body of water at low tide. In other embodiments, near the low tide edge of the body of water may mean more than 10 feet from the edge of the body of water at low tide. In the context of this disclosure, areas near the body of water in some embodiments may include areas reached by the water at high tide.

In one embodiment, as illustrated in FIG. 3D, collecting the hydrophobic absorbent material 390 containing at least some of the hydrocarbon material 310 includes closing the net 340 such that it substantially encloses at least some of the hydrophobic absorbent material, and removing the net 340 from the body of water 320. In one embodiment, removing the net 340 includes lifting and pulling the net 340. The net 340 may be removed to land by using a tractor 395 or some other land transportation methods or vehicles, or the net 340 may be removed to the deck of a ship, a barge, a dock, a truck, a helicopter, and so on. In other embodiments, the net is first floated or pulled behind a ship to remove it from the collection area and is later placed onto a ship, barge, dock, truck, helicopter or other vehicle. In another embodiment, collecting the hydrophobic absorbent material 390 containing at least some of the hydrocarbon material 310 includes removing the hydrophobic absorbent material 390 from the net 340.

In another embodiment (not shown), a system similar to system 300 may be used for recovering hydrocarbon materials from the body of water so as to prevent at least some of the hydrocarbon material from reaching land and other areas near the land-edge of the body of water. The embodiment includes securing the net near the surface of the body of water, deploying hydrophobic absorbent material on the surface of the body of water, and allowing the hydrophobic absorbent material to absorb at least some of the hydrocarbon material from the body of water. The net and the hydrophobic absorbent material are deployed such that at high tide at least some of the hydrophobic absorbent material floats out with the tide towards the net. During the transition from low tide to high tide, at least some of the hydrophobic absorbent material floats with the tide towards the net.

This embodiment may further include collecting the hydrophobic absorbent material containing at least some of the hydrocarbon material. In one embodiment, collecting the hydrophobic absorbent material containing at least some of the hydrocarbon material includes closing the net such that the net substantially encloses at least some of the hydrophobic absorbent material, and removing the net substantially enclosing the collected hydrophobic absorbent material. In another embodiment, collecting the hydrophobic absorbent material includes removing the hydrophobic absorbent material from the net.

In yet another embodiment, securing the net and deploying the hydrophobic absorbent material includes deploying preassembled boom including the net and the hydrophobic absorbent material.

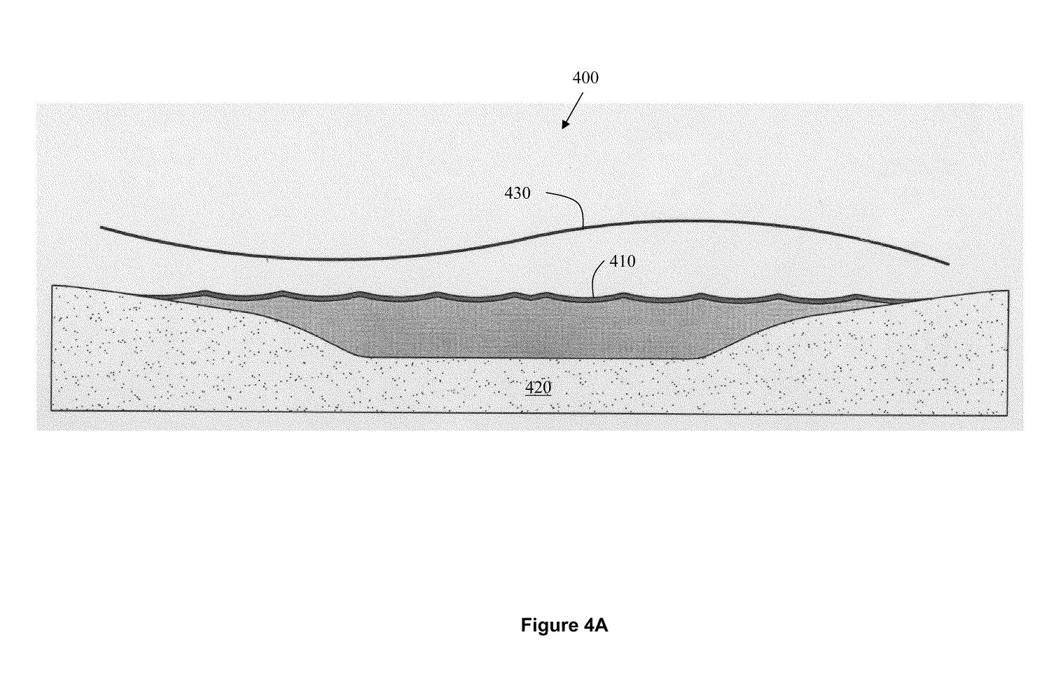

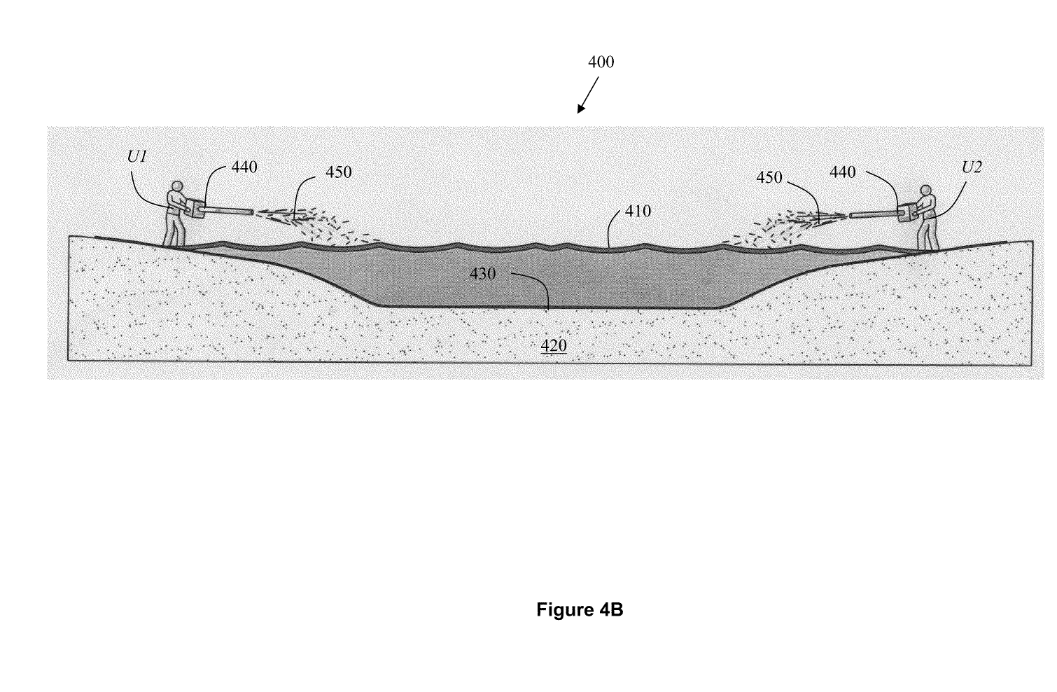

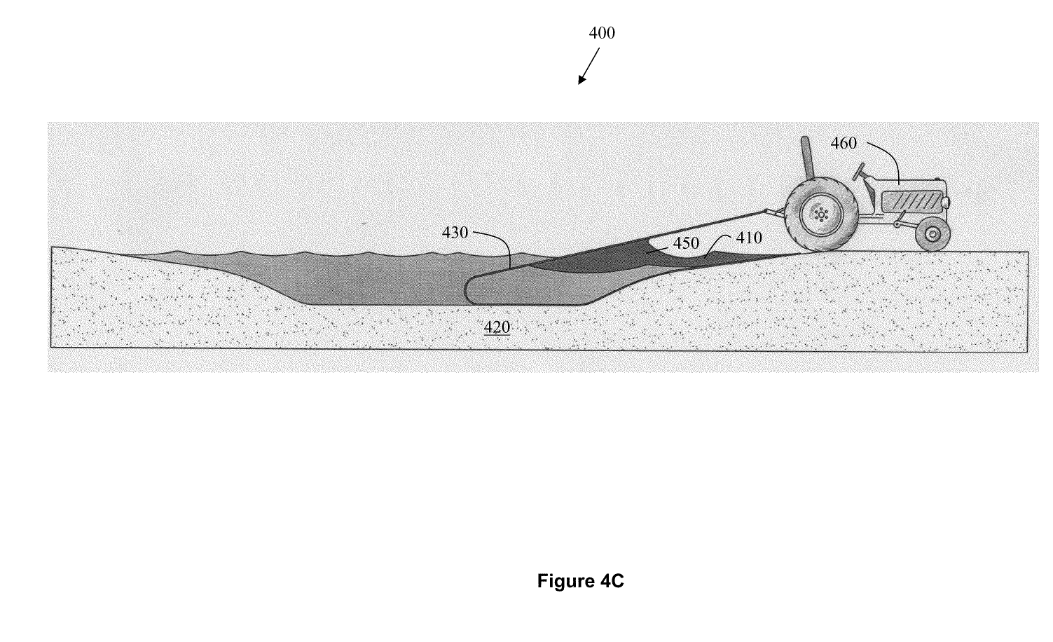

FIGS. 4A, 4B, and 4C illustrate an exemplary system 400 and method of recovering hydrocarbons 410 from an area 420 that is contaminated or threatened with contamination with the hydrocarbons 410. The system 400 includes a net 430, and a mechanism 440 configured to deploy or assist in deployment of hydrophobic absorbent material 450.

In the illustrated embodiment, the mechanism 440 configured to deploy or assist in deployment of the hydrophobic absorbent material 450 is shown as two units being carried and operated by users U1 and U2. In other embodiments (not shown), the mechanism configured to deploy or assist in deployment of hydrophobic absorbent material may be, not carried or operated by users, but mounted (e.g. removably mounted, permanently mounted, etc.) to a base, a vehicle, and so on, and self-operated or operated by, for example, a machine. In other embodiments, (not shown) the mechanism configured to deploy or assist in deployment of the hydrophobic absorbent material may include more or less than two units. The mechanism may deploy the hydrophobic absorbent material by accelerating portions of the hydrophobic absorbent material by using pressurized air. In other embodiments, the mechanism may deploy or assist in deployment of the hydrophobic absorbent material by using methods other than pressurized air (e.g. a mechanical process, a manual process, and so on).

A method of recovering the hydrocarbons 410 from the area 420 includes deploying the net 430 on the area 420, deploying the hydrophobic absorbent material 450 such that at least some of the hydrophobic absorbent material 450 contacts at least some of the hydrocarbons 410, allowing the hydrophobic absorbent material 450 to absorb at least some of the hydrocarbons 410, and collecting the hydrophobic absorbent material 450 from the area 420.

In one embodiment, collecting the hydrophobic absorbent material 450 includes closing the net 430 such that it substantially encloses at least some of the hydrophobic absorbent material 450 and removing the net 430 from the area 420. The net 430 may be removed to land by using the tractor 460 or some other land method or vehicle, or the net 430 may be removed to the deck of a ship, land, a barge, a dock, a truck, a helicopter, and so on. In another embodiment, collecting the hydrophobic absorbent material 450 includes removing the hydrophobic absorbent material 450 from the net 430.

An “operable connection,” or a connection by which components are “operably connected,” is one by which the operably connected components or the operable connection perform its intended purpose. For example, two components may be operably connected to each other directly or through one or more intermediate components.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” is employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.”

While the present application illustrates various embodiments, and while these embodiments have been described in some detail, it is not the intention of the applicant to restrict or in any way limit the scope of the claimed invention to such detail. Departures may be made from such details without departing from the spirit or scope of the applicant's claimed invention. Therefore, the invention, in its broader aspects, is not limited to the specific details, the representative apparatus, and illustrative examples shown and described.

1. A method of recovering hydrocarbons from the surface and near surface of a body of water, the method comprising:
deploying a hydrophobic absorbent material including cellulose treated with borax onto the surface;
allowing the hydrophobic absorbent material to absorb at least some of the hydrocarbons; and
collecting the hydrophobic absorbent material into a netting apparatus operably attached to a ship in the body of water.

2. The method of claim 1, where the borax is at least one of hydrated and non-hydrated sodium borate.

3. The method of claim 1, where the cellulose in the hydrophobic absorbent material includes cardboard.

4. The method of claim 1, where the deploying includes:
accelerating portions of the hydrophobic absorbent material onto the water by using at least one of pressurized air, a mechanical process, and a manual process.

5. The method of claim 1, where the allowing the hydrophobic absorbent material to absorb at least some of the hydrocarbons includes controlling the navigation speed of the ship.

6. The method of claim 1, where the netting apparatus includes a frame operably attached to at least one of the port side of the hull, the starboard side of the hull, the bow, the deck, and the stern of the ship.

7. The method of claim 1, where the netting apparatus includes a frame operably attached to the ship using at least one bracket attached to a first portion of the frame and at least one rope attached to a second portion of the frame.

8. The method of claim 1, where the netting apparatus includes a frame operably attached to the ship, where the frame has operably attached at least one diving lip extending from a bottom end of the frame such that at least a portion of the at least one diving lip is submerged in the body of water so that oil below the surface of the water rises to the surface.

9. The method of claim 1, where the netting apparatus includes a frame operably attached to the ship and a net operably attached to the frame, where the frame has operably attached at least one flap extending from a front end of the frame such that the at least one flap acts as a funnel directing at least some of the hydrophobic absorbent material towards the net.

10. The method of claim 1, where the netting apparatus includes a frame and a net having a major opening, and where the net is removably attached to the frame, the method further comprising:
(1) removing the net from the frame;
(2) closing the major opening such that the collected hydrophobic absorbent material is substantially enclosed; and
(3) removing the net with the collected hydrophobic absorbent material from the body of water, wherein (1), (2) and (3) can take place in any order.

11. The method of claim 10, where the removing the net includes:
lifting the net from the water; and
moving the net to one of a water vehicle, an air vehicle, a land vehicle, a dock, and land.

12. The method of claim 1, where the netting apparatus includes a net having a major opening, a first frame operably attached to the net near the major opening, and a second frame operably attached to the ship and removably attached to the first frame, the method further comprising:
(1) removing the first frame from the second frame;
(2) closing the major opening such that the collected hydrophobic absorbent material is substantially enclosed; and
(3) removing the net with the collected hydrophobic absorbent material from the body of water, wherein (1), (2) and (3) can take place in any order.

13. The method of claim 1, where the netting apparatus includes:
a frame,
a net attached to the frame, and
a plurality of floating devices attached to the net around at least a portion of the net such that a portion of the net remains substantially near, on, or above the surface of the body of water.

14. The method of claim 1, where the hydrocarbons include oil, diesel, xylene, touluene, benzene, gasoline, and bunker C oil.

15. A method of recovering a hydrocarbon material from at least one of a body of water and areas near the body of water, the method comprising:
securing a net near a low tide edge of the body of water;
deploying hydrophobic absorbent material including cellulose on an area on or near the body of water;
allowing the hydrophobic absorbent material to absorb at least some of the hydrocarbon material;
where the hydrophobic absorbent material is deployed on the area on or near the body of water such that at high tide at least some water from the body of water contacts at least some of the hydrophobic absorbent material and such that at a subsequent low tide at least some of the hydrophobic absorbent material floats with the tide towards the net; and
collecting the hydrophobic absorbent material containing at least some of the hydrocarbon material.

16. The method of claim 15, where the hydrocarbon material is petroleum-based.

17. The method of claim 15, where the hydrophobic absorbent material is treated with a chemical having at least one of the chemical formulas:
Na₂B₄O₇;
Na₂B₄O₇.5H₂O;
Na₂B₄O₇.10H₂O;
and
Na₂[B₄O₅(OH)₄].8H₂O.

18. The method of claim 15, where the cellulose in the hydrophobic absorbent material includes cardboard and the cellulose is treated with wax.

19. The method of claim 15, where the collecting the hydrophobic absorbent material containing at least some of the hydrocarbon material includes at least one of:
(1) closing the net such that the net substantially encloses the at least some of the hydrophobic absorbent material, and removing the net substantially enclosing the hydrophobic absorbent material; and
(2) removing the hydrophobic absorbent material from the net.

20. The method of claim 19, where the removing the net substantially enclosing the collected hydrophobic absorbent material includes:
lifting the net enclosing the collected hydrophobic absorbent material; and
placing the net enclosing the collected hydrophobic absorbent material onto one of a land vehicle, an air vehicle, a water vehicle, a dock, and a barge.

21. The method of claim 15, where the securing the net and the deploying the hydrophobic absorbent material includes:
deploying preassembled boom including the net and the hydrophobic absorbent material.

22. A method of recovering hydrocarbons from an area that is contaminated or threatened with contamination with the hydrocarbons, the method comprising:
deploying a net on the area;
deploying hydrophobic absorbent material including cellulose treated with borax on or above the net such that at least some of the hydrophobic absorbent material contacts at least some of the hydrocarbons;
allowing the hydrophobic absorbent material to absorb at least some of the hydrocarbons; and
collecting the hydrophobic absorbent material from the area.

23. The method of claim 22, where the borax has at least one of the chemical formulas:
Na₂B₄O₇;
Na₂B₄O₇.5H₂O;
Na₂B₄O₇.10H₂O;
and
Na₂[B₄O₅(OH)₄].8H₂O.

24. The method of claim 22, where the hydrophobic absorbent material includes cardboard and bees wax.

25. The method of claim 22, where collecting the hydrophobic absorbent material includes at least one of:
(1) closing the net such that the net substantially encloses the hydrophobic absorbent material, and removing the net; and
(2) removing the hydrophobic absorbent material from the net.

26. The method of claim 22, where the net is attached to a plurality of floating devices such that at least a portion of the net remains substantially near, on, or above the surface of a body of water.

27. A method of recovering a hydrocarbon material from a body of water, the method comprising:
securing a net near at or near the surface of the body of water;
deploying hydrophobic absorbent material including cellulose on the surface of the body of water;
allowing the hydrophobic absorbent material to absorb at least some of the hydrocarbon material from the body of water; and
where the hydrophobic absorbent material is deployed on the surface of the body of water near the net such that at high tide at least some of the hydrophobic absorbent material floats with the tide towards the net.

28. The method of claim 27, where the hydrophobic absorbent material has been treated with borax having at least one of the chemical formulas:
Na₂B₄O₇;
Na₂B₄O₇.5H₂O;
Na₂B₄O₇.10H₂O;
and
Na₂[B₄O₅(OH)₄].8H₂O.

29. The method of claim 27, further comprising:
collecting the hydrophobic absorbent material containing at least some of the hydrocarbon material, where the collecting includes at least one of:
(1) closing the net such that the net substantially encloses at least some of the hydrophobic absorbent material, and removing the net substantially enclosing the collected hydrophobic absorbent material; and
(2) removing the hydrophobic absorbent material from the net.

30. The method of claim 27, where the securing the net and the deploying the hydrophobic absorbent material includes:
deploying preassembled boom including the net and the hydrophobic absorbent material.
